(19) United States
(12) Patent Application Publication
(10) Pub. No.: US 2016/0321190 A1
(43) Pub. Date: Nov. 3, 2016

(54) COMPUTATION OF DESTAGE TASKS BASED ON RANKS WITH WRITE OPERATIONS

(71) Applicant: INTERNATIONAL BUSINESS MACHINES CORPORATION, Armonk, NY (US)

(72) Inventors: Kevin J. ASH, Tucson, AZ (US); Lokesh M. GUPTA, Tucson, AZ (US); Matthew J. KALOS, Tucson, AZ (US)

(73) Assignee: INTERNATIONAL BUSINESS MACHINES CORPORATION, Armonk, NY (US)

(21) Appl. No.: 14/697,987

(22) Filed: Apr. 28, 2015

(51) Int. Cl. G06F 12/12

(52) U.S. Cl. CPC G06F 12/128; G06F 12/122; G06F 2212/69

(57) ABSTRACT

Various embodiments provide methods, systems, and computer program products for destaging storage tracks from cache in at least one host, by a processor device. One method comprises monitoring the cache for write operations from the at least one host, and destaging storage tracks from the cache based upon a threshold of at least one of a frequency of track usage, a total cache size, and a number of ranks with write operations.

### BACKGROUND OF THE INVENTION

1. Field of the Invention

The present invention relates in general to computing systems, and more particularly, to systems and methods for background destaging storage tracks from cache when one or more hosts coupled to the cache are idle.

2. Description of the Related Art

One goal of computer storage systems is to reduce the number of destage conflicts when destaging storage tracks from a write cache so that the storage system operates more efficiently and/or faster. A destage conflict can occur when a storage track is being destaged from the write cache while a host is trying to write data to the storage track. Storage systems must create a balance of mitigating these conflicts while providing reliability and without sacrificing overall performance.

### SUMMARY OF THE INVENTION

Various embodiments provide methods, systems, and computer program products for destaging storage tracks from cache in at least one host, by a processor device. One method comprises monitoring the cache for write operations from the at least one host, and destaging storage tracks from the cache based upon a threshold of at least one of a frequency of track usage, a total cache size, and a number of ranks with write operations.

In addition to the foregoing exemplary embodiment, various other system and computer program product embodiments are provided and supply related advantages. The foregoing summary has been provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 illustrates a block diagram showing an exemplary hardware structure for effecting management of multipath I/O, in which aspects of the present invention may be realized;

FIG. 2 is a flow diagram of one embodiment of a method for destaging storage tracks from a write cache;

FIG. 3 is a flow diagram of one embodiment of a method for determining if one or more hosts is/are idle; and

FIG. 4 is a flow diagram of one embodiment of a method for destaging storage tracks from a write cache.

### DETAILED DESCRIPTION OF THE DRAWINGS

Various embodiments provide methods, systems, and computer program products for destaging storage tracks from cache in at least one host, by a processor device. As will be further discussed, one method comprises monitoring the cache for write operations from the at least one host, and destaging storage tracks from the cache based upon a threshold of at least one of a frequency of track usage, a total cache size, and a number of ranks with write operations.

As aforementioned, one goal of computer storage systems is to reduce the number of destage conflicts when destaging storage tracks from a write cache so that the storage system operates more efficiently and/or faster. A destage conflict can occur when a storage track is being destaged from the write cache while a host is trying to write data to the storage track. This situation may be created because contemporary storage systems typically destage storage tracks shortly after the storage track is written to and the host must wait until the storage track is destaged from the write cache before the host is able to again write to the storage track.

One technique to reduce the number of destage conflicts includes keeping storage tracks in the write cache for a longer period of time before destaging the storage tracks so that a storage track may be written to multiple times before the storage track is destaged. While this is an effective technique for reducing destage conflicts, it is also desirable that storage tracks not reside in the write cache too long so that the data in the storage tracks does not become stale.

Present methods of computing destage task control blocks (TCBs) for a particular cache rank generally rely on computing two factors. One factor is the total non-volatile storage (NVS) occupancy for a rank. The other is the total NVS occupancy for all ranks One particular issue with this calculation is there is no lower threshold on a rank for destage TCBs when the calculated global pressure factor is high. In this way, if a rank has few tracks but the global pressure is high, the rank may still have a large number of destage TCBs. In other words, if the total NVS occupancy of a rank is low, however the overall NVS usage is high (or the total NVS occupancy for all ranks), the computation of destage TCBs for the rank is still high.

This situation causes the rank to destage all tracks, driving the number of tracks on the rank to zero. Additionally, in another example, the background destage may present another issue because generally background destage operations spin off four destage TCBs every second for all ranks in the storage controller. Background destage operations generally run every second and create four destage TCBs for every rank in a given number of NVS tracks. If these tracks are sequential and can be grouped easily, the background destage may further drive the number of tracks on a rank to a very low number.

Destaging all tracks on a particular rank creates at least two conflicts. Tracks that are continually updated may be destaged multiple times, reducing the throughput of writes. Additionally, there is a higher chance that a track being written to is required to wait for the destage of the track to finish, causing a spike in overall response times.

The present invention seeks to mitigate the aforementioned conflicts by providing an efficient calculation for destaging storage tracks, particularly when the host system is idle.

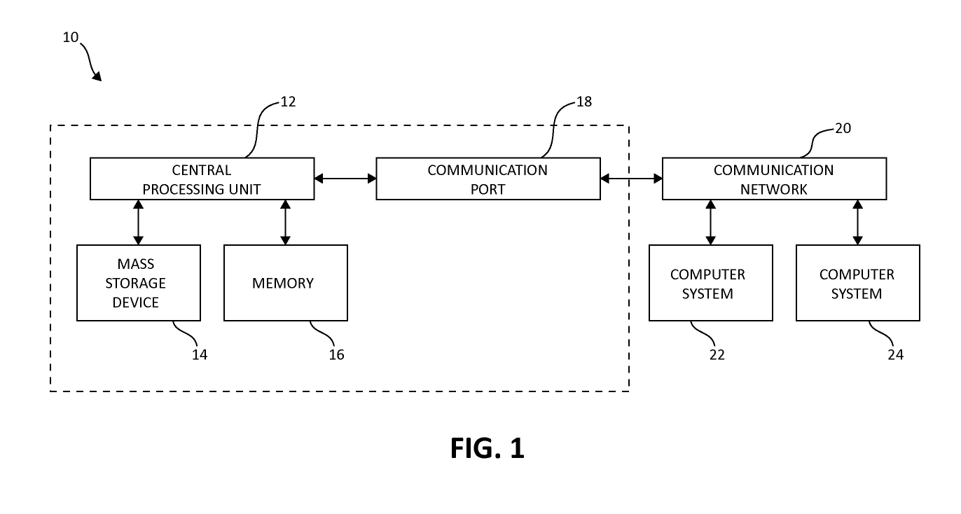

Turning now to FIG. 1, exemplary architecture 10 of a computing system environment is depicted. Architecture 10 may, in one embodiment, be implemented at least as part of a system for effecting mechanisms of the present invention. The computer system 10 includes central processing unit (CPU) 12, which is connected to communication port 18 and memory device 16. The communication port 18 is in communication with a communication network 20. The communication network 20 and storage network may be configured to be in communication with server (hosts) 22, 24 and storage systems, which may include storage devices 14. The storage systems may include hard disk drive (HDD) devices, solid-state devices (SSD) etc., which may be configured in a redundant array of independent disks (RAID). The communication port 18, communication network 20, and other components not pictured for the sake of brevity but known to the skilled artisan may include such hardware components as fibre channel cabling, fibre channel ports, Host-Bus Adapters (HBAs), Converged Network Adapters (CNAs), network switches and switching components, and similar communications mechanisms known to one of ordinary skill in the art. Various aspects of the illustrated embodiments may be realized using one or more of these components as will be further described.

The operations as described below may be executed on storage device(s) 14, located in system 10 or elsewhere and may have multiple memory devices 16 working independently and/or in conjunction with other CPU devices 12. Memory device 16 may include such memory as electrically erasable programmable read only memory (EEPROM) or a host of related devices. Memory device 16 and storage devices 14 are connected to CPU 12 via a signal-bearing medium. In addition, CPU 12 is connected through communication port 18 to a communication network 20, having an attached plurality of additional computer host systems 22, 24. In addition, memory device 16 and the CPU 12 may be embedded and included in each component of the computing system 10. Each storage system may also include separate and/or distinct memory devices 16 and CPU 12 that work in conjunction or as a separate memory device 16 and/or CPU 12.

### RANK IDLE DESTAGE

In U.S. patent application Ser. No. 12/965,133, now U.S. Pat. No. 8,661,201, filed Dec. 10, 2010, which application is incorporated herein by reference, and assigned to the same assignee as the present application, a method is discussed in which a foreground destage method destages storage tracks from a cache (e.g., cache 16) until a predetermined threshold percentage of memory is being used by the various ranks of the cache. That is, the foreground destage process destages storage tracks from each rank until the respective ranks each include a predetermined amount of storage tracks.

For example, if the write cache includes ten (10) ranks, each rank will be allocated ten percent (10%) of the total storage capacity of the write cache if each rank is allocated the same amount of storage space in the write cache, although two or more ranks may include different storage space allocations. If, the predetermined threshold for this example is thirty percent (30%), the foreground destage process will destage storage tracks from each rank until each rank is 30% full. In other words, the foreground destage process will destage storage tracks from each rank until each rank is using three (3%) of the total storage capacity of the write cache (i.e., 30%·10%=3%).

When a rank reaches its respective threshold, storage tracks are no longer destaged from the rank until the rank is written to by the host and the rank is using more than the threshold amount of storage space. After the predetermined threshold for each rank has been reached, a “background” destaging process may begin destaging the remaining storage tracks from the write cache if the host is not writing to a rank or the host is otherwise deemed idle, which is controlled by processor 12.

Processor 12, in one embodiment, comprises a background destage process module (not pictured) to control the background destaging process in cache 16. That is, background destage process module comprises code that, when executed by processor 12, causes processor 12 to perform a method for background destaging storage tracks from cache 16 when host(s) 10 is/are idle. The background destaging process may begin when the predetermined threshold of storage space is reached in a particular rank as discussed in the example above or when other predetermined conditions are met, which may vary depending on the application of the background destaging process.

In one embodiment, processor 12 is configured to monitor cache 16 for write operations from host(s) 10 to determine if host(s) 10 is/are idle. In one embodiment, idleness is determined at the cache level. In this embodiment, host(s) 10 is/are considered idle if host(s) 10 is/are not writing to storage tracks in cache 16. Alternatively, host(s) 10 is/are considered active or not idle if host(s) 10 is/are writing to one or more storage tracks in cache 16.

In another embodiment, idleness is determined at the rank level on a per rank basis. In this embodiment, host(s) 10 is/are considered idle with respect to a particular rank if host(s) 10 is/are not writing to storage tracks in that particular rank. Alternatively, host(s) 10 is/are considered active or not idle with respect to a particular rank if one or more of hosts 10 is writing to one or more storage tracks in that particular rank. As such, host(s) 10 may be considered idle with respect to a first rank and not idle or active with respect to a second rank in cache 16.

In one embodiment, when determining if host(s) 10 is/are idle, processor 12 is configured to set or reset a flag on cache 16 each time a host 10 writes to cache 16 in embodiments that determine idleness at the cache level. In another embodiment, processor 12 is configured to set or reset a flag on each respective rank each time a host 10 writes to the rank in embodiments that determine idleness at the rank level. In the various embodiments, the flag is set or reset to a predetermined count each time a host 10 writes to cache 16 or to a storage track in a particular rank.

The predetermined count may be any predetermined integer and/or fraction of an integer. In one embodiment, the predetermined count is two (2) counts. In other embodiments, the predetermined count is greater than or less than 2 counts, including fractions of counts.

Processor 12 is configured to decrement each flag in accordance with a predetermined amount of time from the last time a host 10 wrote to cache 16 in embodiments that determine idleness at the cache level or from the last time a host 10 wrote to each respective rank in embodiments that determine idleness at the rank level. In one embodiment, the predetermined amount of time for decrementing each flag is one (1) second. In other embodiments, the predetermined amount of time for decrementing each flag is greater than or less than one (1) second, including fractions of seconds.

Processor 12 is configured to refrain from destaging storage tracks when processor 12 determines that host(s) 10 is/are active or not idle. That is, processor 12 does not destage storage tracks when the flag count for cache 16 or the flag count on a flag for an associated rank is greater than zero. When processor 12 determines that host(s) 10 is/are idle (i.e., when the flag count for cache 16 or the flag count on a flag for an associated rank is equal to zero), processor 12 is configured to begin destaging storage tracks from each rank in cache 16 in embodiments that determine idleness at the cache level or from each rank for which host(s) 10 is/are determined to be idle with respect to in embodiments that determine idleness at the rank level.

In one embodiment, processor 12 is configured to destage storage tracks from each rank at a rate of four (4) storage tracks per second when performing the background destage process. In other embodiments, processor 12 is configured to destage storage tracks from each rank at a rate of one (1), two (2), or three (3) storage tracks per second when performing the background destage process. In still other embodiments, processor 12 is configured to destage storage tracks from each rank at a rate greater than four (4) storage tracks per second when performing the background destage process.

The following example may be helpful in understanding how host(s) 10 is/are determined to be idle at the rank level and how storage tracks are destaged from cache 16. In this example, cache 16 is partitioned into five (5) ranks (e.g., rank 1, rank 2, rank 3, rank 4, and rank 5), each being allocated twenty percent (20%) of the total storage space of cache 16 and where the predetermined threshold amount of storage space in each rank is thirty percent (30%) of their respective allocated amount of total storage space (e.g., 20%·30%=6%). In addition, each rank includes an associated flag for assisting processor 12 in determining if host(s) 10 is/are idle with respect to each rank (e.g., flag 1 is associated with rank 1, flag 2 is associated with rank 2, flag 3 is associated with rank 3, flag 4 is associated with rank 4, and flag 5 is associated with rank 5), each respective flag is incremented two (2) counts each time one of hosts 10 writes to is associated rank, each flag is decremented one (1) count every second after one of hosts 10 writes to a storage track in its associated rank, and four (4) storage tracks are destaged each time processor 12 determines that host(s) 10 is/are idle with respect to a particular rank. At time 1 (the predetermined threshold of 30% is reached in this example (i.e. each rank is storing 6% of the total storage space of cache 16)), one of hosts 10 writes to a storage track in each of rank 1, rank 2, rank 3, rank 4, and rank 5 and sets the flag count in each of flag 1, flag 2, flag 3, flag 4, and flag 5 to two counts. At time 2, one of hosts 10 (i.e., the same host or a different host) writes to one or more storage tracks in rank 1 and rank 4, and processor 12 increments flag 1 and flag 2 to two counts each and decrements flag 2, flag 3, and flag 5 by one count each such that flag 2, flag 3, and flag 5 are each at one count. At time 3, one of hosts 10 (i.e., the same host or a different host) writes to one or more storage tracks in rank 5 and in rank 4, and processor 12 increments flag 4 and flag 5 to two counts each and decrements each of flag 1, flag 2, and flag 3 by one count each such that flag 1 has one count, flag 2 has zero counts, and flag 3 has zero counts. At time 4, one of hosts 10 (i.e., the same host or a different host) writes to rank 4 and to rank 5, and processor 12 increments flag 4 and flag 5 to two counts each, decrements flag 1 to zero counts, and destages four storage tracks from each of rank 2 and rank 3. At time 5, none of hosts 10 write to any storage tracks and processor 12 will destage four storage tracks from each of rank 1, rank 2, and rank 3, and decrement rank 4 and rank 5 by one count each such that flag 4 and flag 5 each have one flag count. At time 6, one of hosts 10 (i.e., the same host or a different host) writes to one or more storage tracks in rank 5 and processor 12 will increment flag 5 to two flag counts, decrement flag 4 by one flag count such that flag 4 has zero flag counts, and destage four storage tracks from each of rank 1, rank 2, and rank 3. At time 7, one of hosts 10 (i.e., the same host or a different host) writes to one or more storage tracks in flag 5 and processor 12 will increment flag 5 to two flag counts and destage four storage tracks from each of rank 1, rank 2, rank 3, and rank 4. At time 8, one of host 10 (i.e., the same host or a different host) writes to one or more storage tracks in flag 5 and processor 12 will increment flag 5 to two flag counts and destage four storage tracks from each of rank 1, rank 2, rank 3, and rank 4. At time 9, none of hosts 10 write to any storage tracks in rank 5 and processor 12 decrements flag 5 by one flag count such that flag 5 has one flag counts and destage four storage tracks from each of rank 1, rank 2, rank 3, and rank 4. At time 10, none of hosts 10 write to any storage tracks in rank 5 and processor 12 destages four storage tracks from each of rank 1, rank 2, rank 3, rank 4, and rank 5. This process continues until all of the storage tracks are destaged from each respective rank and/or cache 16 or each respective rank is using more than the predetermined threshold amount of storage space.

### COMPUTING DESTAGE TCBs

In one embodiment, when computing destage TCBs for a particular rank, the number of tracks in the cache B-tree is checked for the rank. Using the following formula, where numNVSTracks is the number of tracks on the rank, and cntNVSSegments is the number of segments on the rank, an example computation is made as follows.
A minimum size for the rank is computed:

minSize=(30% of NVS size)/17/ownedRanks
A global pressure factor is computed based on NVS free segment count and NVS high priority:
level(25% of NVS) and NVS quiesce level(90%);
If (NVS free segment count<NVS high priority level, globalPressureFactor=0; otherwise,
if (NVS free segment count>NVS quiesce level), globalPressureFactor=100; otherwise,

globalPressureFactor=((NVS free segment count−NVS high priority level)*100)/(NVS quiesce level−NVS high priority level);
A low threshold (lowNVSThreshold) and high threshold (highNVSThreshold) is computed:

highNVSThreshold=NVS limit for a rank (i.e. 25%)−minSize

highNVSThreshold=90% of highNVSThreshold*globalPressureFactor;
Compute highNVSThreshold1 based on number of ranks with write I/O:
(i.e. 75% of total NVS size divided by number of ranks with writes):

highNVSThreshold1=(75*Total NVS size)/(Number of ranks with writes*100);
Use minimum two high NVS thresholds (highNVSTThreshold, highNVSTThreshold1), as computed above:
highNVSThreshold=Minimum of highNVSThreshold and highNVSThreshold1
lowNVSThreshold=70% of highNVSThreshold;
Use the global pressure factor to increase high NVS threshold:

highNVSThreshold2=(75*total NVS size)/(number of ranks with writes*100−GlobalPressureFactor)
highNVSThreshold=Maximum of highNVSThreshold, highNVSThreshold2;
Compute destage 1 TCBs count as follows:
if (numNVSSegments<lowerThreshold), destage TCBs count=0 otherwise,

destage TCBs count=1+((MAX DESTAGES ALLOWED−1)*(cntNVSSegments−lowNVSThreshold))/(highNVSThreshold−lowNVSThreshold);
Maximum Destage TCBs allowed=40;
Do not have more than one TCB per 20 tracks for number of tracks on the B-tree of the rank:

destage TCBs count=minimum of (numNVSTracks+19)/20 or computed destage TCBs from formula above;
If there are no new write operations (newWrites is 0) for over a second and computed destage TCBs is less than four, spinoff 4 background destage TCBs.

In one embodiment, as calculated above, a high level threshold is computed by processor 12 based upon a number of ranks with write input/output operations (I/O). In this example, the threshold is computed as seventy-five percent (75%) of the total computed storage space divided by the number of ranks with present write I/O. As aforementioned, a minimum of two thresholds are computed as a high threshold in cache 16 by processor 12, and a low threshold is computed the total storage space of cache 16, where the predetermined threshold amount of storage space in each rank is thirty percent (30%) of their respective allocated amount of total storage space.

In this embodiment, a global pressure factor described in the computation discussed above may be used to increase the high level threshold. For example, the high level threshold may be the computed threshold of seventy-five percent (75%) of the total storage space divided by the number of ranks with write I/O (or the number of ranks with write I/O multiplied by the total amount of storage space minus the computed global pressure factor). Hosts 10 may use this computation instead of or in addition to the aforementioned example in destage operations until all of the storage tracks are destaged from each respective rank and/or cache 16 or each respective rank is using more than the predetermined threshold amount of storage space.

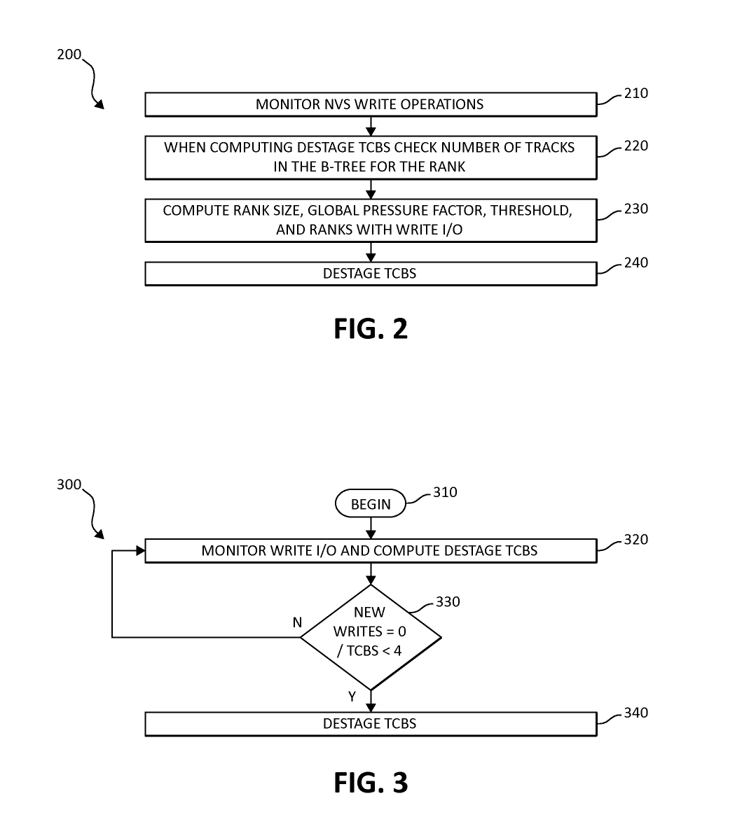

With regard to FIG. 2, a method of destaging storage tracks 200 is illustrated. As computed above, the method begins by monitoring the host 10 for NVS write operations 210. When computing destage TCBs (i.e. using the aforementioned formula), the number of tracks in the cache 16 B-tree is checked for the particular rank 220. At least a rank size, global pressure factor, a high threshold and a low threshold, and ranks with current write operations are computed 230. Based upon the calculations and as previously discussed, TCBs are then destaged at a predetermined rate 240.

Turning to FIG. 3, a method of computing, destaging, and refraining from destaging TCBs 300 is illustrated. Beginning at 310, NVS write operations are monitored and TCBs are computed 320 to determine if the host 10 is idle. If no new writes are made for one (1) second, (i.e. newWrites=0) or the amount of TCBs is less than a predetermined amount (i.e. 4) 330, the TCBs are destaged at a predetermined rate 340. If the host 10 is determined not to be idle (step 330), the write operations and computed TCBs are continued to be monitored 320.

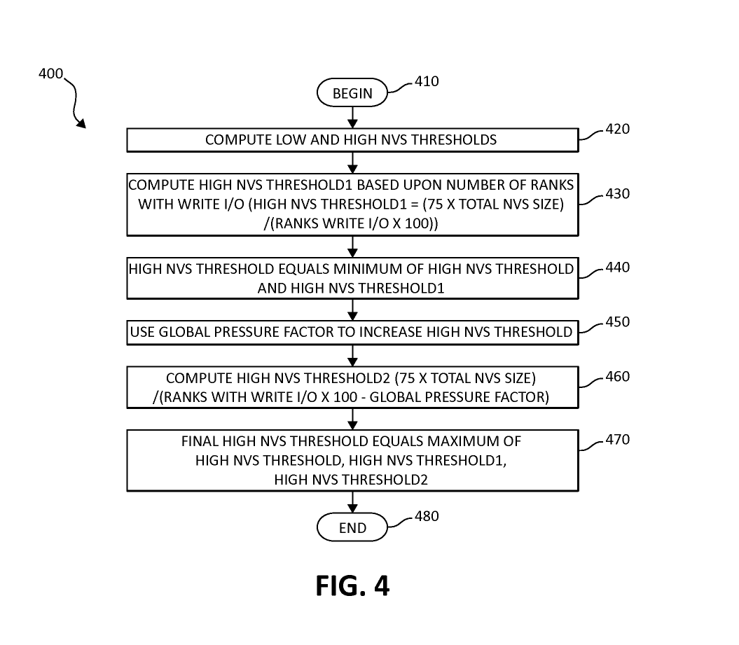

With regard to FIG. 4, still another method of computing destage TCBs 400 is illustrated. Beginning at 410, high level NVS thresholds (i.e. highNVSThreshold) and low level NVS thresholds (i.e. lowNVSThreshold) are computed as formulated above 420. An additional high NVS threshold (i.e. highNVSThreshold1) is then computed based upon the number of ranks with current write operations, using the aforementioned formula in paragraph [0031] 430. The high level NVS threshold equals the minimum of the computed highNVSThreshold and highNVSThreshold1 440. Using the global pressure factor, the high NVS threshold is then increased 450. A additional high level NVS threshold is then computed (i.e. highNVSThreshold2) as described in the formula above 460. The final high NVS threshold is then computed equaled to the maximum of highNVSThreshold, highNVSThreshold1, and highNVSThreshold2 470. The method ends 480.

While one or more computation and example formula has been illustrated, it should be noted that the aforementioned illustrations are examples only. Variants within the illustrated calculations, threshold levels, predetermined amounts of time, and number of TCBs to be destaged exist while staying within the scope of the present invention.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While one or more embodiments of the present invention have been illustrated in detail, the skilled artisan will appreciate that modifications and adaptations to those embodiments may be made without departing from the scope of the present invention as set forth in the following claims.

1. A method for destaging storage tracks from cache in at least one host, by a processor device, the method comprising:
monitoring the cache for write operations from the at least one host, and
destaging storage tracks from the cache based upon a threshold of at least one of a frequency of track usage, a total cache size, and a number of ranks with write operations.

2. The method of claim 1, further including calculating destage operations by computing a plurality of high level thresholds and low level thresholds based upon the number of ranks with current write operations.

3. The method of claim 1, the method further including:
monitoring each cache rank for write operations from the at least one host based upon a calculated threshold to determine if the at least one host is idle; and
destaging storage tracks if it is determined that the at least one host is idle.

4. The method of claim 3, further including refraining from destaging storage tracks if it is determined that the at least one host is not idle.

5. The method of claim 3, further including destaging a predetermined number of storage tracks per second from each rank in which the at least one host is determined to be idle with respect to.

6. The method of claim 4, further including:
determining that the at least one host is idle when the at least one host does not write to at least one storage track within a predetermined amount of time when determining if the at least one host is idle with respect to each rank; and
determining that the at least one host is not idle when the at least one host writes to at least one storage track within the predetermined amount of time when determining if the at least one host is idle with respect to each rank.

7. The method of claim 6, further including setting a flag to a predetermined count on each respective rank every time one of the at least one host writes to at least one storage track on each rank.

8. The method of claim 7, further including decrementing the flag on each respective rank for every predetermined unit of time in which the at least one host does not write data to each rank.

9. A system for destaging storage tracks from cache in at least one host, the system comprising:
a write cache configured to store a plurality of storage tracks and configured to be coupled to the at least one host; and
a processor coupled to the write cache, wherein the processor:
monitors the cache for write operations from the at least one host, and
destages storage tracks from the cache based upon a threshold of at least one of a frequency of track usage, a total cache size, and a number of ranks with write operations.

10. The system of claim 9, wherein the processor calculates destage operations by computing a plurality of high level thresholds and low level thresholds based upon the number of ranks with current write operations.

11. The system of claim 9, wherein the processor:
monitors each cache rank for write operations from the at least one host based upon a calculated threshold to determine if the at least one host is idle; and
destages storage tracks if it is determined that the at least one host is idle.

12. The system of claim 11, wherein the processor refrains from destaging storage tracks if it is determined that the at least one host is not idle.

13. The system of claim 11, wherein the processor destages a predetermined number of storage tracks per second from each rank in which the at least one host is determined to be idle with respect to.

14. The system of claim 11, wherein the processor:
determines that the at least one host is idle when the at least one host does not write to at least one storage track within a predetermined amount of time when determining if the at least one host is idle with respect to each rank; and
determines that the at least one host is not when the at least one host writes to at least one storage track within the predetermined amount of time when determining if the at least one host is idle with respect to each rank.

15. The system of claim 12, wherein the processor sets a flag to a predetermined count on each respective rank every time the at least one host writes to at least one storage track in a particular rank.

16. The system of claim 13, wherein the processor decrements the flag on each respective rank for every predetermined unit of time in which the at least one host does not write data to at least one storage track in a particular rank.

17. A computer program product for destaging storage tracks from cache in at least one host, by a processor device, the computer program product comprising a non-transitory computer-readable storage medium having computer-readable program code portions stored therein, the computer-readable program code portions comprising:
a first executable portion that monitors the cache for write operations from the at least one host, and
a second executable portion that destages storage tracks from the cache based upon a threshold of at least one of a frequency of track usage, a total cache size, and a number of ranks with write operations.

18. The computer program product of claim 17, further including a third executable portion that calculates destage operations by computing a plurality of high level thresholds and low level thresholds based upon the number of ranks with current write operations.

19. The computer program product of claim 17, further including a third executable portion that:
monitors each cache rank for write operations from the at least one host based upon a calculated threshold to determine if the at least one host is idle; and
destages storage tracks if it is determined that the at least one host is idle.

20. The computer program product of claim 19, further including a fourth executable portion that refrains from destaging storage tracks if it is determined that the at least one host is not idle.

21. The computer program product of claim 19, further including a fourth executable portion that: destages a predetermined number of storage tracks per second from each rank in which the at least one host is determined to be idle with respect to.

22. The computer program product of claim 20, further including a fifth executable portion that:
determines that the at least one host is idle when the at least one host does not write to at least one storage track within a predetermined amount of time when determining if the at least one host is idle with respect to each rank; and
determines that the at least one host is not when the at least one host writes to at least one storage track within the predetermined amount of time when determining if the at least one host is idle with respect to each rank.

23. The computer program product of claim 22, further including a sixth executable portion that sets a flag to a predetermined count on each respective rank every time the at least one host writes to at least one storage track in a particular rank.

24. The computer program product of claim 23, further including a seventh executable portion that decrements the flag on each respective rank for every predetermined unit of time in which the at least one host does not write data to at least one storage track in a particular rank.
